(19) United States
(12) Patent Application Publication
(10) Pub. No.: US 2010/0264199 A1
(43) Pub. Date: Oct. 21, 2010

(54) JOINING METHOD FOR METAL MEMBERS

(75) Inventors: Taisei Wakisaka, Hagagun (JP); Takanori Suzuki, Hagagun (JP); Tokuji Okumura, Hagagun (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/799,066

(22) Filed: Apr. 16, 2010

(30) Foreign Application Priority Data
Apr. 17, 2009 (JP) 2009-100902

(51) Int. Cl. B23K 1/20

(52) U.S. Cl. 228/256

(57) ABSTRACT

The present invention provides a joining method for metal members, including: preparing an Fe-based metal member of Fe-based material, and an Al-based metal member of Al-based material; providing a Zn-based brazing filler metal between the Fe-based metal member and the Al-based metal member; and joining the Fe-based metal member and the Al-based metal member, wherein the Zn-based brazing filler metal includes: 2.0 mass % or less of Al; and the balance of Zn and inevitable impurities, and in the joining, the Zn-based brazing filler metal is heated such that a liquid phase of the Zn-based brazing filler metal is generated, and in solidification of the Zn-based brazing filler metal in a condition of the liquid phase, Zn primary crystal or eutectic of Zn and Al is crystallized.

### BACKGROUND OF THE INVENTION

1. Field of the Invention

The present invention relates to a joining method for metal members in which a Fe-based metal member and an Al-based metal member are joined via a Zn-based brazing filler metal. In particular, it relates to an improvement in a heating technique during joining of them.

2. Description of Related Art

Joint structures (for example, various joints) of metal members are produced by joining of dissimilar metal members. In joining of dissimilar metal members, brazing is performed such that laser beam is irradiated on a brazing filler metal provided between the dissimilar metal members and the brazing filler metal is heated. Thus, a joint layer is formed between the dissimilar metal members, so that a joint structure of metal members is formed.

For example, when a Fe-based metal member of Fe-based material and an Al-based metal member of Al-based material are used, Al and Zn do not form a compound layer, and they forms an eutectic texture at a large area, so that a Zn-based brazing filler metal is used as a brazing filler metal as disclosed in, for example, Japanese Patent No. 3740858. Thus, strength can be secured between the Al-based metal member and the joint layer.

However, an intermetallic compound layer, which is formed at a boundary portion between the Fe-based metal member and the joint layer, is brittle, so that fracture may occur thereat. As a result, strength of the joint structure of metal members may be insufficient.

### SUMMARY OF THE INVENTION

An object of the present invention is to provide a joining method for metal members which can improve joint strength of boundary portion between a Fe-based metal member and a joint layer and which can thereby improve joint strength of the Fe-based metal member and the Al-based metal member.

The inventors keenly studied on the brazing filler metal and the input heat condition used in joining of dissimilar metal members which were Fe-based metal member and Al-based metal member. FIG. 7 is a diagram showing a binary alloy equilibrium condition of ZnAl. In FIG. 7, the horizontal axes show included content of Zn, the unit of the horizontal axis of the upper side is weight % (wt %), and the unit of the horizontal axis of the lower side is atomic percent (at %). As shown in FIG. 7, primary crystal, which is crystallized in solidification of Zn-based brazing filler metal portion in a liquid phase condition, is different between at the left side of the eutectic point and at the right side of the eutectic point (that is, at the Al-rich side, Al primary crystal is crystallized, and at the Zn-rich side, Zn primary crystal is crystallized.). The inventors focused attention on this fact, and the inventors found that in solidification of Zn-based brazing filler metal in a liquid phase condition, it is important to prevent generation of Al primary crystal in order to prevent formation of intermetallic compound layer. The present invention was made based on this finding.

According to one aspect of the present invention, a joining method for metal members includes: preparing an Fe-based metal member of Fe-based material, and an Al-based metal member of Al-based material; providing a Zn-based brazing filler metal between the Fe-based metal member and the Al-based metal member; and joining the Fe-based metal member and the Al-based metal member, wherein the Zn-based brazing filler metal includes: 2.0 mass % or less of Al; and the balance of Zn and inevitable impurities, and in the joining, the Zn-based brazing filler metal is heated such that a liquid phase of the Zn-based brazing filler metal is generated, and in solidification of the Zn-based brazing filler metal in a condition of the liquid phase, Zn primary crystal or eutectic of Zn and Al is crystallized. In the specification, a portion to be joined is a portion between the Fe-based metal member and the Al-based metal member which will be joined. A joint portion is a portion to be joined after joining (that is, a portion which has been joined).

In the joining method of the aspect of the present invention, in the joining of the Fe-based metal member and the Al-based metal member, the Zn-based brazing filler metal, which includes: 2.0 mass % or less of Al; and the balance of Zn and inevitable impurities, is used as the Zn-based brazing filler metal provided between the metal members, and the Zn-based brazing filler metal is heated such that in the solidification of the Zn-based brazing filler metal in the condition of the liquid phase, Zn primary crystal or eutectic of Zn and Al is crystallized. Since the Zn-based brazing filler metal is heated in this manner, as understood by FIG. 7, in the solidification of the Zn-based brazing filler metal, Al primary crystal is not crystallized, so that Al(α) (alpha-aluminum, alpha-solid solution) does not exist in the Zn-based brazing filler metal in the liquid phase condition. In this case, even when a Zn-based brazing filler metal, which includes Al of which content corresponds to a ratio (a ratio at the eutectic point and at the Zn-rich side in FIG. 7) at which Al primary crystal is not crystallized, Al of the Al-based metal member may be melted into the Zn-based brazing filler metal in the joining, and the condition may be transited to the condition of the Al-rich side in the diagram of binary alloy equilibrium condition of ZnAl shown in FIG. 7. Therefore, it is important to set the heating condition of the Zn-based brazing filler metal in the above manner.

Therefore, reaction of the Al primary crystal and the Fe-based metal member due to direct contact thereof does not occur, so that in the joint structure obtained by the joining method, intermetallic compound layer of FeAl-based compound cannot be formed at the boundary portion between the Fe-based metal member and the joint layer. In the conventional technique, intermetallic compound layer at the boundary portion between the Fe-based metal member and the joint layer may be brittle, so that strength of the joint structure may be deteriorated. In contrast, in the embodiment of the present invention, formation of intermetallic compound layer can be prevented, so that the strength at the boundary portion between the Fe-based metal member and the joint layer can be improved.

According to the joining method of the present invention, since intermetallic compound layer cannot be formed at the boundary portion between the Fe-based metal member and the joint layer, the strength at the boundary portion between the Fe-based metal member and the joint layer can be improved and another effect can be obtained.

### BRIEF DESCRIPTION OF THE DRAWINGS

FIGS. 1A and 1B show a condition in which a joint structure is produced by a joining method for metal members of one embodiment according to the present invention. FIG. 1A is a schematic perspective view showing this condition, and FIG. 1B is a schematic side view showing a portion to be joined.

FIG. 2 shows a production process of the joining method for metal members of one embodiment according to the present invention, and FIG. 2 is a conceptual diagram which show a boundary portion between a Fe-based metal member and a Zn-based brazing filler metal.

FIGS. 3A and 3B show a production process, which follows that of FIG. 2, of the joining method for metal members of one embodiment according to the present invention, and FIG. 3 is a conceptual diagram which show a boundary portion between a Fe-based metal member and a Zn-based brazing filler metal

FIGS. 4A and 4B show a production process, which follows that of FIG. 2, of conventional joining method for metal members of one embodiment according to the present invention.

FIG. 5 is a cross sectional view which shows a structure of the portion to be joined, at which a key hole is formed, in joining of the metal members of the embodiment according to the present invention.

FIG. 6 is a cross sectional view which shows one example of a joint structure obtained by the joining method for metal members of the embodiment according to the present invention.

FIG. 7 is a diagram showing a binary alloy equilibrium condition of ZnAl.

FIGS. 8A and 8B are SEM images showing a joint structure of metal members of sample 11, and FIG. 8A is a SEM image showing a texture of joint layer, and FIG. 8B is a SEM image showing a texture of boundary portion between a Fe-based metal member and the joint layer.

FIGS. 9A and 9B are SEM images showing a joint structure of metal members of comparative sample 12, and FIG. 9A is a SEM image showing a texture of joint layer, and FIG. 9B is a SEM image showing a texture of boundary portion between a Fe-based metal member and the joint layer.

FIGS. 10A and 10B are SEM images showing a joint structure of metal members of sample 21, and FIG. 10A is a SEM image showing a texture of joint layer, and FIG. 10B is a SEM image showing a texture of boundary portion between a Fe-based metal member and the joint layer.

FIGS. 11A and 11B are SEM images showing a joint structure of metal members of comparative sample 31, and FIG. 11A is a SEM image showing a texture of joint layer, and FIG. 11B is a SEM image showing a texture of boundary portion between a Fe-based metal member and the joint layer.

FIGS. 12A and 12B are SEM images showing a joint structure of metal members of comparative sample 32, and FIG. 12A is a SEM image showing a texture of joint layer, and FIG. 12B is a SEM image showing a texture of boundary portion between a Fe-based metal member and the joint layer.

FIG. 13 is a cross sectional diagram which schematically shows a joint structure for explaining a method of peel strength test.

### DESCRIPTION OF THE PREFERRED EMBODIMENTS

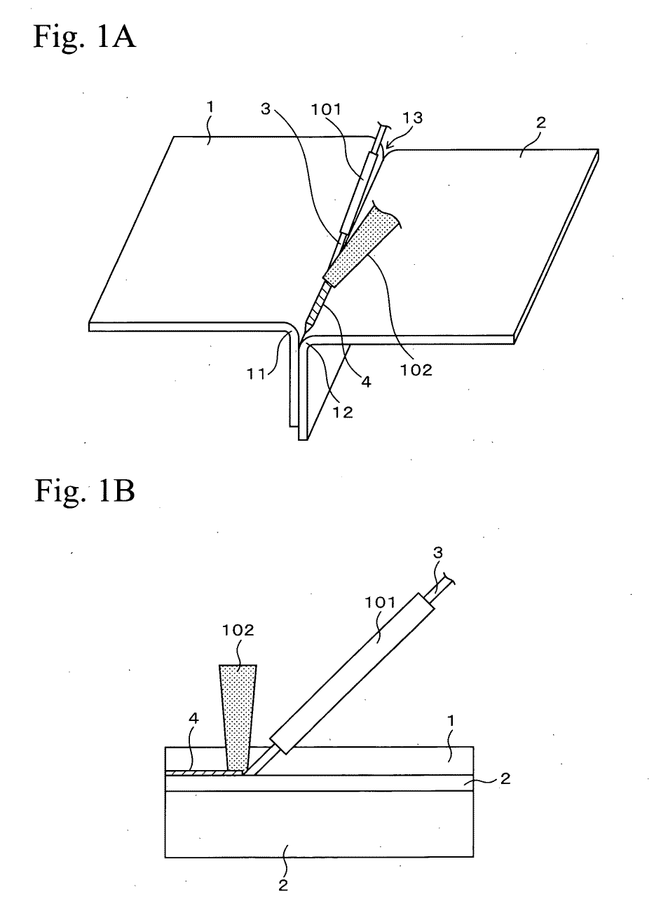

One embodiment of the present invention will be described hereinafter with reference to Figures. FIGS. 1A and 1B show a condition in which a joining method for metal members of one embodiment according to the present invention is performed. FIG. 1A is a schematic perspective view showing the condition, and FIG. 1B is a schematic side view showing a portion to be joined.

The joining method for metal members uses a layout for production of flare joint. An Fe-based metal member 1 of a Fe-based material and an Al-based metal member 2 of a Al-based material are uses as metal members. The Fe-based metal member 1 and the Al-based metal member 2 have curved portions 11 and 12. In the layout of the Fe-based metal member 1 and the Al-based metal member 2, the curved portions 11 and 12 face each other, and a groove shape 13 is thereby formed. In this case, for example, a step is provided at a facing portion of the Fe-based metal member 1 and the Al-based metal member 2.

In the joining method for metal members of the embodiment, while a Zn-based brazing filler metal 3, which has a wire shape, is supplied to a center portion of the groove shape 13, which is formed by the curved portions 11 and 12 of the Fe-based metal member 1 and the Al-based metal member 2, through a wire guide 101, laser beam 102 is irradiated onto a leading end portion of the Zn-based brazing filler metal 3. The Zn-based brazing filler metal 3 includes: 2.0 mass % or less of Al; and the balance of Zn and inevitable impurities.

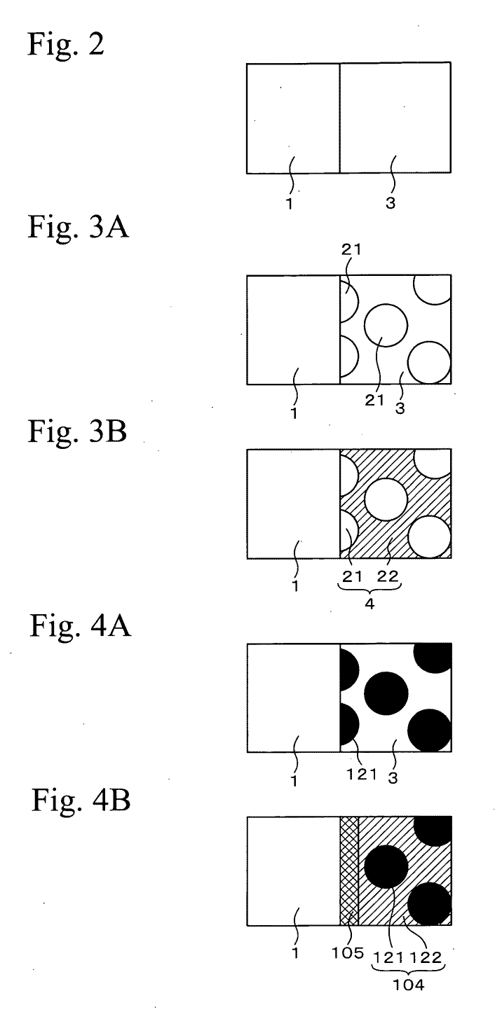

The Zn-based brazing filler metal 3 is heated by the irradiation of the laser beam 102, and as shown in FIG. 2, the Zn-based brazing filler metal 3 is in a liquid phase condition. Then, the Zn-based brazing filler metal 3 in the liquid phase condition is solidified, so that a joint layer 4 is formed between the Fe-based metal member 1 and the Al-based metal member 2.

In the conventional technique, as shown in FIG. 4A, in the solidification of the Zn-based brazing filler metal 3 in the liquid phase condition, Al primary crystal 121, which is Al crystal; is crystallized. The Al primary crystal 121 exists as a simple substance of Al(α) (alpha-aluminum, alpha-solid solution), the Al primary crystal 121 directly contacts the Fe-based metal member 1 which is in a solid phase condition, and the Al primary crystal 121 reacts with the Fe-based metal member 1. Due to this, as shown in FIG. 4B, a joint layer 104, which has a texture of the Al primary crystal 121 and eutectic 122 of Zn and Al, is formed, and an intermetallic compound layer 105, which includes Fe—Al based compound, is formed at a boundary portion between the Fe-based metal member 1 and the joint layer 104. In FIG. 4B, diagonal line portion shows a condition that the eutectic 122 is solidified.

In contrast, in the embodiment, as shown in FIG. 3A, the Zn-based brazing filler metal 3 is heated such that Zn primary crystal 21, which is Zn crystal, or eutectic 22 of Zn and Al is crystallized in solidification of the Zn-based brazing filler metal 3 which is in a liquid phase condition. The Zn primary crystal 21 exists as a simple substance of Zn(β) (beta-zinc, beta-solid solution). Thus, in the solidification of the Zn-based brazingfiller metal 3, Al primary crystal is not crystallized, so that Al(α) (alpha-aluminum, alpha-solid solution) does not exist in the Zn-based brazing filler metal 3 which is in the liquid phase condition. Therefore, direct contact and reaction of the Al primary crystal and the Fe-based metal member 1 do not occur. As a result, as shown in FIG. 3B, the joint layer 4, which has a texture of the Zn primary crystal 21 and the eutectic 22 of Zn and Al, is formed. In this case, an intermetallic compound layer is not formed at a boundary portion between the Fe-based metal member 1 and the joint layer 4. In FIG. 3B, diagonal line portion shows a solidified condition that the eutectic 22 is solidified.

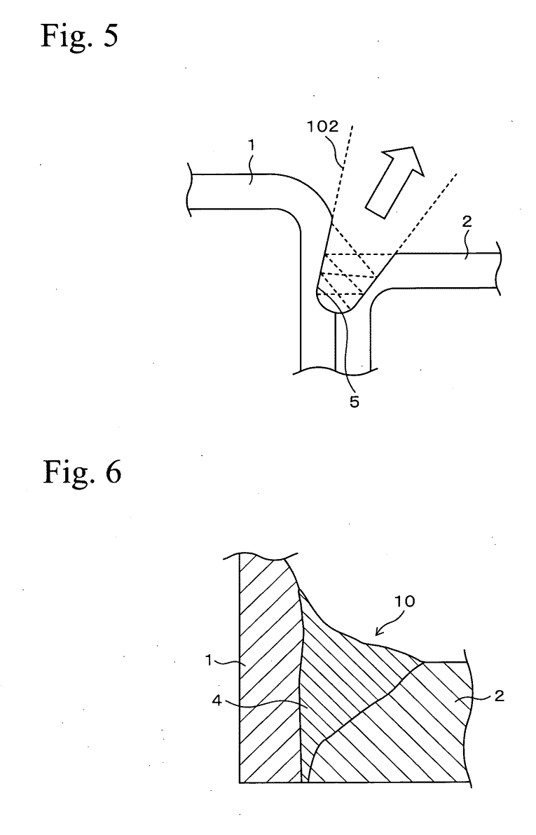

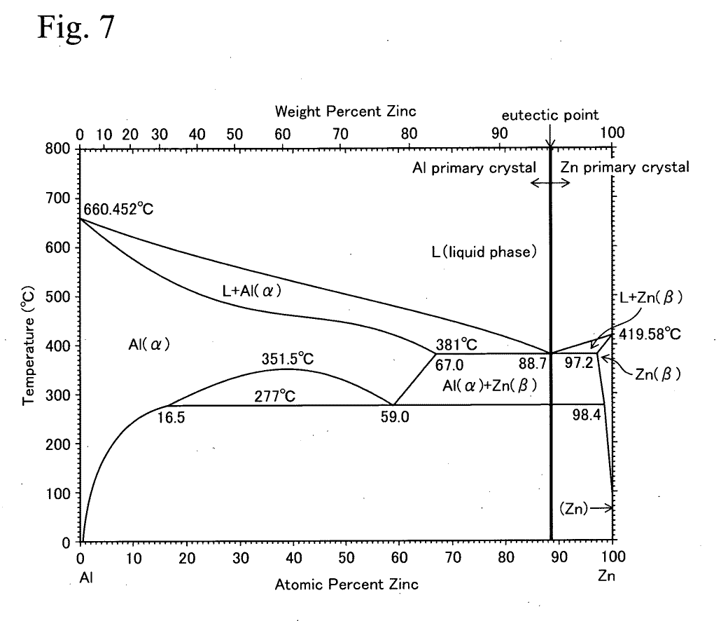

In the irradiation of the laser beam 102, it is desirable to heat a portion of the Fe-based metal member 1 and the Al-based metal member 2 to be joined to a temperature equal to or more than a melting point of the Fe-based material. FIG. 5 is a cross sectional view which shows a structure of the portion 5 to be joined, at which a key hole 5 is formed, during joining of the Fe-based metal member 1 and the Al-based metal member 2. At the portion 5 to be joined, melting and evaporation of materials occurs by heating, and the key hole 5 is formed by reaction force (of which direction is shown by the arrow direction in FIG. 5) by evaporated materials. In this case, the melted Zn-based brazing filler metal 3 exists around a portion onto which the laser beam 102 is irradiated. In this key hole 5, multiple reflection of the laser beam 102 occurs as shown by dotted line in FIG. 5, so that energy density is higher in the key hole 5, and the overall surface from the upper side to the lower side of the key hole 5 is about uniformly heated. After the laser beam 102 passes, the melted Zn-based brazing filler metal, which enters the key hole 5, can react with the overall surface of the key hole 5 so as to have a uniform thermal history.

In the above manner, the heating by the irradiation of the laser beam 102 is performed from the front side to the back side in FIG. 1A in an extending direction of the groove shape 13, so that as shown in FIG. 6, a joint structure 10 of the Fe-based metal member 1 and the Al-based metal member 2 can be produced.

The joint structure 10 has the Fe-based metal member 1 and the Al-based metal member 2, and the joint layer 4 is formed therebetween. In the joining method of the embodiment, Al of the Al-based metal member 2 enters the joint layer 4 by eutectic melting of Zn and Al or melting of Al, so that the joint layer 4 includes Al even when the Zn-based brazing filler metal 3 does not include Al. In this embodiment, differently from the conventional joint structure, intermetallic compound layer, which was formed in the conventional joint structure, does not exist at the boundary portion between the Fe-based metal member 1 and the joint layer 4.

As described above, in the embodiment, in the joint structure 10 obtained by the joining, intermetallic compound layer is not formed at the boundary portion between the Fe-based metal member 1 and the joint layer 4. In the conventional technique, intermetallic compound layer at the boundary portion between the Fe-based metal member and the joint layer was brittle, so that strength of the joint structure may was lower. In contrast, in the embodiment, intermetallic compound layer is not formed, strength at the boundary portion between the Fe-based metal member 1 and the joint layer 4 can be improved.

In the above embodiment, the joining method for the metal members of the present invention is explained by using laser welding, and the joining method is not limited thereto, and it can use various methods instead of the laser welding. For example, spot welding can be used. Specifically, Zn-based brazing filler metal, which has a sheet shape, is used, the Zn-based brazing filler is held between the Fe-based metal member and the Al-based metal member, and spot welding is performed.

### EXAMPLES

The present invention will be explained in detail with reference to specific examples.

In samples 11 and 21 and comparative samples 12, 31 and 32, an Fe-based metal member and an Al-based metal member were disposed in the same manner as the layout in FIGS. 1A and 1B, and a groove shape was formed by curved portions thereof. While a Zn-based brazing filler metal, which had a wire shape, was supplied to a center portion of the groove shape through a wire guide, laser beam was irradiated onto a leading end portion of the Zn-based brazing filler metal. Thus, joint structures of the metal members were produced. Table 1 shows conditions of the joining.

In the samples 11 and 21 and the comparative samples 12, 31 and 32, as shown in Table 1, the content of Al included in the Zn-based brazing filler metal and the heat input condition were mainly varied. In Table 1, regarding the material of the Zn-based brazing filler metal, the included content (added content, wt %) of Al in the Zn-based brazing filler metal is shown. The Zn-based brazing filler metal included the balance of Zn and inevitable impurities. Regarding the heat input condition, in the low heat input condition, the Zn-based brazing filler metal was heated such that in solidification of the Zn-based brazing filler metal in a liquid phase condition, Zn primary crystal or eutectic of Zn and Al was crystallized. In the high heat input condition, the Zn-based brazing filler metal was heated such that in solidification of the Zn-based brazing filler metal in a liquid phase condition, Al primary crystal was crystallized.

TABLE 1

| | Material of | | | | |
|---|---|---|---|---|---|
| | brazing filler metal | | | Joining | Wire supplying |
| | Al added or none | Heat input | Welding current | velocity | Velocity |
| | Added content of Al | condition | (A) | (mm/min) | (mm/min) |
| sample | Zn | low | 80 | 300 | 2500 |
| 11 | Al: none | | | | |
| comparative | Zn | high | 110 | 300 | 4500 |
| sample | Al: none | | | | |
| 12 | | | | | |
| sample | ZnAl | low | 80 | 300 | 2500 |
| 21 | Added content of | | | | |
| | 2 wt % of Al | | | | |
| comparative | ZnAl | low | 80 | 300 | 2500 |
| sample | Added content of | | | | |
| 31 | 6 wt % of Al | | | | |
| comparative | ZnAl | high | 110 | 300 | 4500 |
| sample | Added content of | | | | |
| 32 | 6 wt % of Al | | | | |

1. SEM Observation of Joint Layer and SEM Observation of Boundary Portion Between Fe-Based Metal Member and Al-Based Metal Member

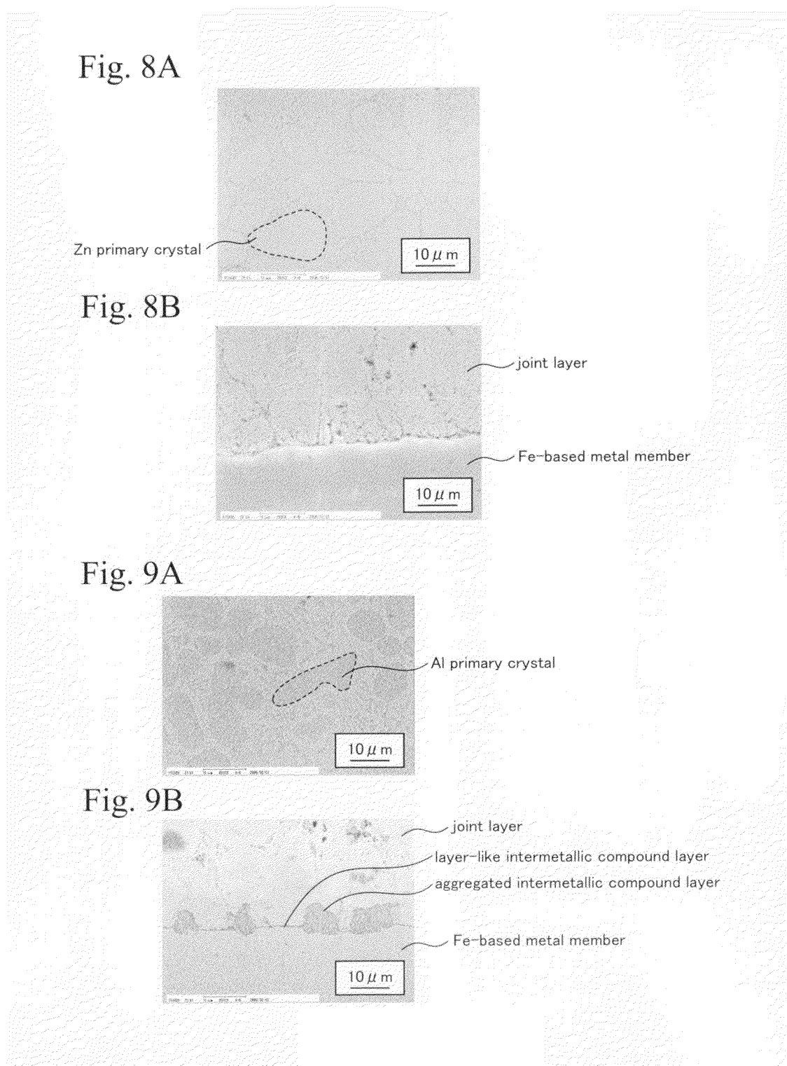

Regarding each of the joint structures of metal members of the samples 11 and 21 and the comparative samples 12, 31 and 32 obtained in the various conditions, texture of joint layer was observed, and texture of boundary portion between the Fe-based metal member and the joint layer was observed by using a Scanning Electron Microscope (SEM). The results were shown in FIGS. 8A to 12A and 8B to 12B. FIGS. 8A to 12A and 8B to 12B are SEM images which show each joint structure of the samples 11 and 21 and the comparative samples 12, 31 and 32. FIGS. 8A to 12A are SEM images which show texture of each joint layer, and FIGS. 8B to 12B are SEM images which show texture of each boundary portion between the Fe-based metal member and the joint layer.

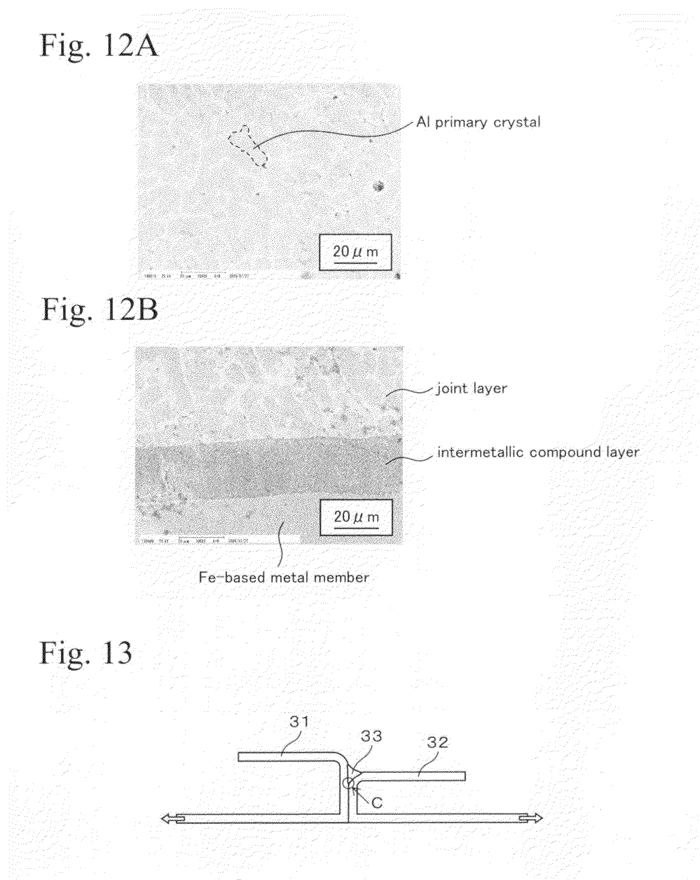

In the comparative samples 12, 31, and 32, of which at least one of the included content of Al in the Zn-based brazing filler metal and the heat input condition were out of the range of the present invention, as shown in FIGS. 9A, 11A, and 12A, Al primary crystal (black island portion in the Figures) was observed. In the Figures, Al primary crystal was shown by the dotted line. In the comparative sample 12, as shown in FIG. 9B, an intermetallic compound layer, which had aggregated intermetallic compound and layer-like intermetallic compound, was observed. In this case, the aggregated intermetallic compound had a size of about 7 μm, and the layer-like intermetallic compound had a layer thickness of about 0 μm. In the comparative samples 31 and 32, as shown in FIGS. 11B and 12B, intermetallic compound layer having a layer thickness of about 20 μm was observed at the boundary portion of the Fe-based metal member and the joint layer.

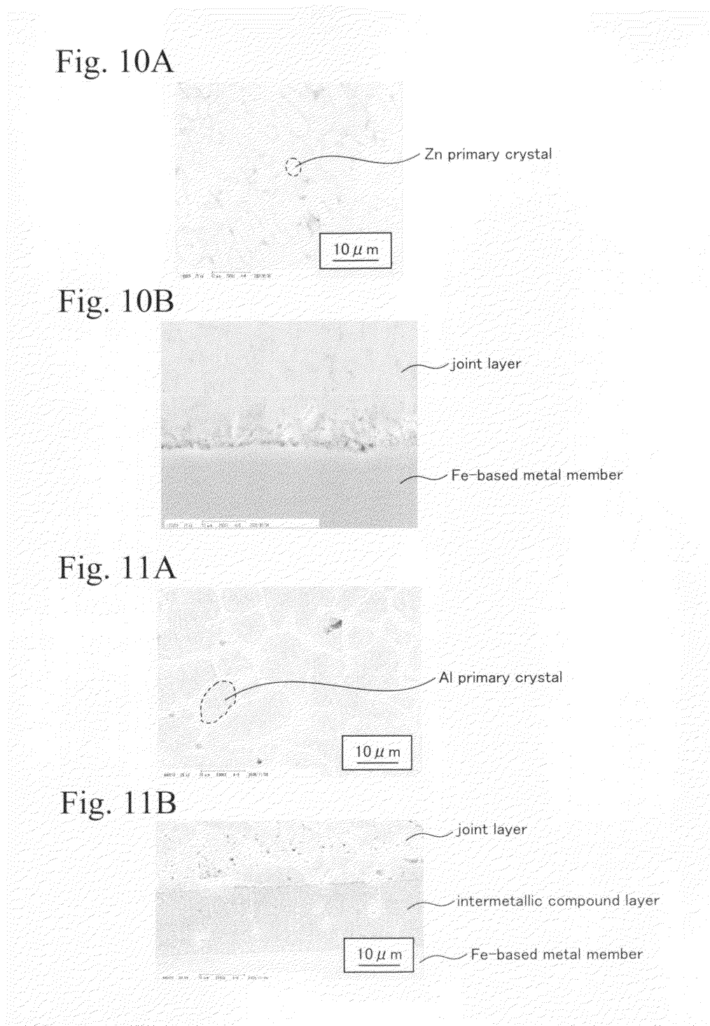

In the samples 11 and 21, of which both the included content of Al in the Zn-based brazing filler metal and heat input condition were within the range of the present invention, as shown in FIGS. 8A and 10A, Al primary crystal was not observed, and Zn primary crystal was observed. In the Figures, the Zn primary crystal was shown by the dotted line. In the sample 11 of the present invention, as shown in FIG. 8B, intermetallic compound layer was not observed at the boundary portion of the Fe-based metal member and the joint layer. In the sample 21 of the present invention, as shown in FIG. 10B, intermetallic compound layer was slightly observed at the boundary portion of the Fe-based metal member and the joint layer, but the layer thickness of the intermetallic compound layer was about 0 μm.

Thus, it was confirmed that formation of intermetallic compound layer could be inhibited at the boundary portion of the Fe-based metal member and the joint layer when the Zn-based brazing filler metal including 2.0 mass % or less of Al was used and the low heat input condition (in which the Zn-based brazing filler metal is heated such that in solidification of the Zn-based brazing filler metal in the liquid phase condition, Zn primary crystal or eutectic of Zn and Al was crystallized) was used in the joining.

2. Evaluation of Joint Strength of Metal Joint Structure

Peal strength tests were performed on test pieces of the samples 11 and 21 and the comparative samples 12, 31, 32. Regarding each of the samples 11 and 21 and the comparative samples 12, 31, 32, three pieces were used as the test pieces. The one piece was a center portion side of the joint structure and the two pieces were both end portion sides of the joint structure.

In the peal strength tests, as shown in FIG. 13, forces opposite to each other were applied at lateral extending portion of the T-shaped portion of Fe-based metal member 31 and Al-based metal member 32, the lateral extending portion being formed on a surface opposite to a surface on which joint layer 33 was formed. In the peal strength tests, high stress is concentrated on joint interface (which is indicated by the arrow mark C), so that strength of the joint interface can be measured. The results (peal tensile strength values) were shown in Table 2. In Table 2, the phrase “interface fracture” denotes that interface fracture occurred in the sample in the peel strength test.

TABLE 2

| | Joint layer | | | |
|---|---|---|---|---|
| | composition ratio | | | |
| | (at %) | | Intermetallic compound layer | Peel strength |
| | Zn | Al | Formed or none Thickness (μm) | (N/20 mm) |
| sample | 96 | 4 | none | 390 |
| 11 | | | | |
| comparative | 93 | 7 | formed | 280 |
| sample | | | (layer-like portion and aggregated portion) | |
| 12 | | | about 0 (thickness of layer-like portion) | |
| | | | 7 (size of aggregated portion) | |
| sample | 95 | 5 | about 0 | 206 |
| 21 | | | | |
| comparative | 65 | 35 | formed | 79 |
| sample | | | 20 | Interface |
| 31 | | | | fracture |
| comparative | 76 | 24 | formed | 163 |
| sample | | | 20 | |
| 32 | | | | |

As shown in Table 2, in comparison with the peal strength of the sample 11 and the comparative sample 12 of which the Zn-based brazing filler metal did not include Al, the peal strength of the sample 11, that intermetallic compound layer was not formed by joining in the low heat input condition, was higher than that of the comparative sample 12, that intermetallic compound layer was formed by joining in the high heat input condition. The peal strength of the sample 21, that the Zn-based brazing filler metal including 2 wt % of Al was used and joining was performed in the low heat input condition, was higher than those of the comparative samples 31 and 32. In this case, as shown in FIG. 1 in the comparative samples 31, the Zn-based brazing filler metal including 6 wt % of Al was used and joining was performed in the low heat input condition, and in the comparative sample 32, the Zn-based brazing filler metal including 6 wt % of Al was used and joining was performed in the high heat input condition. Interface fracture occurred in the comparative sample 31.

Thus, it was confirmed that peal strength could be improved when the Zn-based brazing filler metal including 2.0 mass % or less of Al is used, the low heat input condition is used in the joining, and formation of intermetallic compound layer is thereby inhibited.

What is claimed is:

1. A joining method for metal members, comprising:
preparing an Fe-based metal member of Fe-based material, and an Al-based metal member of Al-based material;
providing a Zn-based brazing filler metal between the Fe-based metal member and the Al-based metal member; and
joining the Fe-based metal member and the Al-based metal member, wherein
the Zn-based brazing filler metal includes: 2.0 mass % or less of Al; and the balance of Zn and inevitable impurities, and
in the joining, the Zn-based brazing filler metal is heated such that a liquid phase of the Zn-based brazing filler metal is generated, and in solidification of the Zn-based brazing filler metal in a condition of the liquid phase, Zn primary crystal or eutectic of Zn and Al is crystallized.
